(19) United States
(12) Patent Application Publication
(10) Pub. No.: US 2016/0119450 A1
(43) Pub. Date: Apr. 28, 2016

(54) METHOD AND SYSTEM FOR VIRTUALIZED NETWORK ENTITY (VNE) BASED NETWORK OPERATIONS SUPPORT SYSTEMS (NOSS)

(71) Applicant: ZTE (USA) Inc., Austin, TX (US)

(72) Inventor: Bhumip Khasnabish, Lexington, MA (US)

(21) Appl. No.: 14/897,905

(22) PCT Filed: Jun. 11, 2014
(86) PCT No.: PCT/US2014/041853

§ 371 Date: Dec. 11, 2015

Related U.S. Application Data
(60) Provisional application No. 61/835,123, filed on Jun. 14, 2013.

(51) Int. Cl. H04L 29/06; G06F 9/455; H04L 12/26

(52) U.S. Cl. CPC H04L 69/18; H04L 43/08; G06F 9/45558; G06F 2009/45595

(57) ABSTRACT

The disclosure relates to a method and system for virtualized network entity (VNE) based network operations and support system (NOSS). The fundamental entity of network operations is VNE. Each VNE provides the necessary computing, storage, and networking features/functions that are desired by the applications (apps) or services. The apps and services provide initial, normal/nominal and overload scenario(s) based VNE configuration request to the NOSS, and the NOSS offers one or more VNE based apps/services support configuration that can be activated flexibly based on the dynamic demands. The requirements and sample operations of the NOSS, for example, attachment of virtualized layer-3 network entities to NOSS via open and interoperable interfaces, are described.

### FIELD OF THE INVENTION

The present invention describes the requirements and sample operations of the network operations and support system (NOSS) where VNEs are the basic entities of NOSS.

These VNEs include router, routing/topology database, DNS, DHCP, firewall, load balancer, etc. Many other devices that offer value-added layer-3 (of ISO's OSI model) services can be also considered as network layer entities. These may include compute, storage, link/channel, routing and forwarding table/engine, firewall, policy/service-quality manager, loan balancer/distributor, etc.

NOSS is a software-defined multi-protocol network compiler (MPNC) which (a) is fully-decoupled from the underlying physical network, and (b) can interwork seamlessly with any other NOSS-visor. It has full visibility and controllability—including configuration and provisioning management—of all of the VNEs that are attached to it irrespective of the domain.

The VNE attachment must be via an open and interoperable interface (IETF ForCES, ONF OF, etc.) that satisfies all of the requirements that are developed in the application herein.

At any point in time, if any of the requirements are violated, the associated VNE can be decommissioned (detached) from the NOSS. Similarly, if a previously detached VNE is repaired or becomes active with compliant interlace, it can be automatically added to the NOSS.

This auto-commissioning/-decommissioning feature has the following advantages: (i) VNEs with faults or faulty interface can be automatically isolated without the overhead of extensive diagnosis, and (ii) capable VNEs with compliant interfaces can be automatically attached to the NOSS.

The VNEs that can be attached to and detached from the NOSS include the following entities:
(Virtualized) network port
(Virtualized) network link
(Virtualized) forwarding table
(Virtualized) DNS
(Virtualized) DHCP sever
(Virtualized) load balancer
(Virtualized) AAA server
(Virtualized) routing engine
(Virtualized) value-added networked service entities

### BACKGROUND OF THE INVENTION

Present day process of virtualization of network entities and attaching them to a Hypervisor is mostly concerned with layer-2 based entities and server-level hypervisor.

Virtualization of layer-3 entities is almost always done on proprietary basis, and the way the VNEs are attached to a network level, if any, Hypervisor uses proprietary interface.

These currently available/practiced methods and solutions create islands of virtualized layer-3 networks and services and defeat the entire motivation of using virtualization, which is to share distributed virtualized resources seamlessly across different domains based on the demand from applications and services. For example, some solutions focus solely on network operating system, some provide seamless access to network management aspects of virtualized entities (not necessarily always the VNEs), and others attempt to support distributed network elements (often virtualized); all use proprietary interface to often ‘undefined’ or proprietary network hypervisor.

The current invention focuses on open and interoperable NOSS based solution instead of operating on layer-2-based Hypervisor domain. Note that layer-2-based Hypervisor typically covers broadcast domain over small geographical (room, campus, a small city, etc.) area, whereas the network layer covers a wide geographical area (like big city, state, country, and beyond), and hence is more attractive for automated repositioning of resources, load balancing and disaster recovery. The Feature Tree for a VNE may include the following entities:
Processing {Virtual, Physical, . . . }
Storage {Virtual, Physical, . . . }
Memory {Virtual, Physical, . . . }
Port {Physical, Logical., Virtual, . . . }
Access {Wireline, Wireless, Physical, Virtual, . . . }
DataPlane {Forwarding, Routing, . . . }
Connectivity {One-Domain, Multi-Domain, . . . }
Transport
Service {Host, Policy, DHCP, DNS, VPN, . . . }

### BRIEF SUMMARY OF THE INVENTION

This invention focuses on attachment of virtualized layer-3 network entities to NOSS via open and interoperable interfaces.

The result is seamless interoperability of distributed virtualized network (layer-3 ) entities and resources over a wider geographical area instead of over a broadcast (layer-2 or local area network or LAN) domain only.

Since NOSS operates truly at the network (layer-3 ) layer, this opens up the possibility of effectively developing wide-area network-aware services and devices, and similarly service-/device-aware networks.

Inputs to the NOSS occur via RESTful APIs in the form of feature (of resources/VNEs) requests for initial, nominal, overload conditions of one or more (cluster) applications or services. The NOSS generates the required configuration and interconnection of the desired resources (VNEs) in for example XML format for initial, nominal, overload scenarios.

In other aspects, the invention provides a system and a computer program having features and advantages corresponding to those discussed above.

For example, the generic port construct may have the following typical features.
Type: Access or Trunk/multiplexing (Binary)
Duplex: Full or Half (Binary)
Speed: Tx and Rx (default and Max) Uint64
Sense: Auto or Forced (Binary)
Bandwidth: Tx and Rx (default and Max) Uint64
MTU: Tx and Rx (default and Max) Uint64
Buffer: Tx and Rx (default and Max) Uint128
Priority: Tx and Rx (default and Assigned) Uint8
StatsCollect (per 3600 sec): Tx and Rx (flushed hourly) Uint128
Address: Tx and Rx (L2−, L2, L2+, L3−, L3, L3+, . . . ) many formats
Tags: Tx and Rx (default and Max)
VLANs: On or Off (Binary)
Tunnels: Tx and Rx (default and Max)
Virtualization: Tx and Rx (default and Max) Uint32
Standby: Hot or Cold (Binary)
Filter: On or Off (Binary)

### BRIEF DESCRIPTION OF THE DRAWINGS

Having thus described the invention in general terms, reference is now made to the accompanying drawings, which are not necessarily drawn to scale. The accompanying drawings are included to provide a further understanding of the invention, and are incorporated in and constitute a part of this specification. The drawings illustrate disclosed embodiments and/or aspects and, together with the description, serve to explain the principles of the invention, the scope of which is determined by the claims.

FIG. 1 shows a high-level schematic of Network Operations Support System (NOSS).

FIG. 2 shows a VNE (Virtual Network Entity) which is the fundamental building block of NOSS.

FIG. 3 demonstrates a typical Lifecycle of VNE which is managed by VNE-Visor which could be a part of the NOSS.

The present inventions will be described more fully hereinafter with reference to the accompanying drawings.

### DETAILED DESCRIPTION OF THE INVENTION

The present inventions is now described more fully hereinafter with reference to the accompanying drawings, as needed, in which some examples of the embodiments of the inventions are shown. It is to be understood that the figures and descriptions provided herein may have been simplified to illustrate elements that are relevant for a clear understanding of the present invention, while eliminating, for the purpose of clarity, other elements found in typical VNE based NOSS systems and methods. Those of ordinary skill in the art may recognize that other elements and/or steps may be desirable and/or necessary to implement the devices, systems, and methods described herein. However, because such elements and steps are well known in the art, and because they do not facilitate a better understanding of the present invention, a discussion of such dements and steps may not be provided herein. The present disclosure is deemed to inherently include all such elements, variations, and modifications to the disclosed elements and methods that would be known to those of ordinary skill in the pertinent art. Indeed, these disclosures may be embodied in many different forms and should not be construed as limited to the embodiments set forth therein; rather, these embodiments are provided by way of example so that this disclosure will satisfy applicable legal requirements. Like numbers refer to like elements throughout.

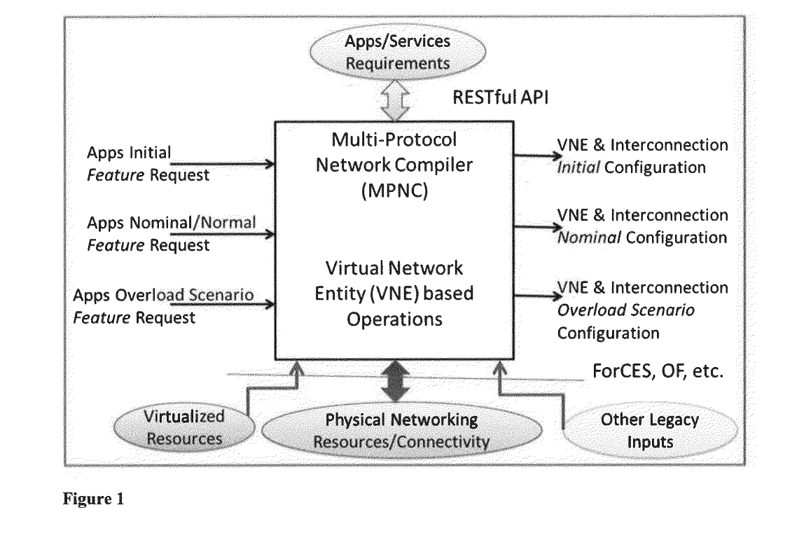

FIG. 1 shows a high-level schematic of Network Operations Support System (NOSS). NOSS is a multi-protocol network compiler (MPNC) which uses abstract network and service entities (Virtual Network Entities (VNEs), and Virtual Service Entities (VS Es) that use a collection of VNEs). The outputs of the NOSS are configurations of the VNEs so that these can be assigned to the appropriate network/service resources for the requesting Apps/services based on initial, nominal., and overload scenarios.

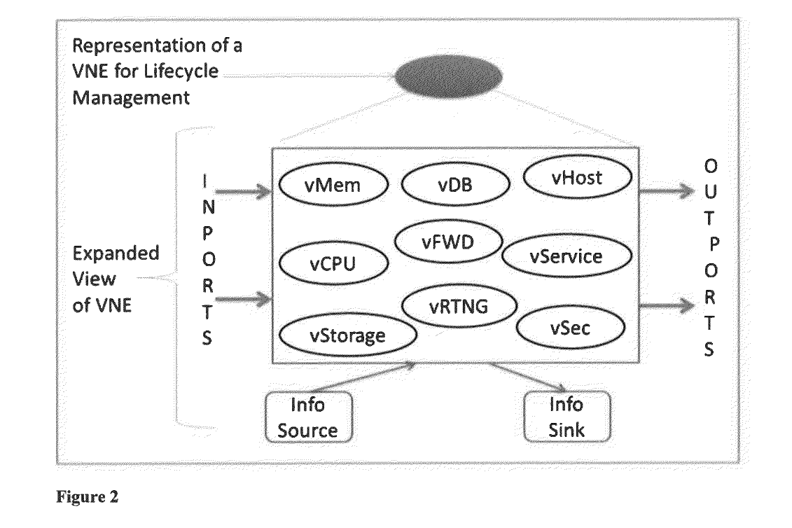

FIG. 2 shows a VNE (Virtual Network Entity) which is the fundamental building block of NOSS. In addition to (virtualized) input/output ports, info source/sink, a VNE also contains (virtualized) storage, processing, networking, value-added elements, etc. resources.

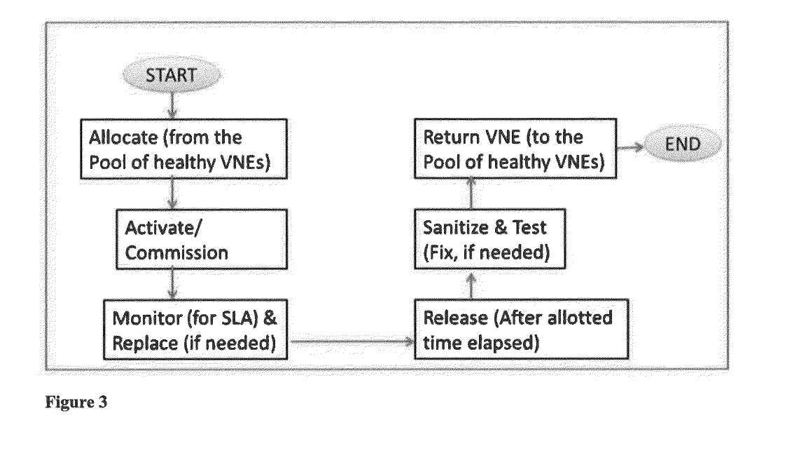

FIG. 3 demonstrates a typical Lifecycle of VNE which is managed by VNE-Visor which could be a part of the NOSS. In addition to allocating and de-allocating the VNE, it is required to keep track (who is using what and for what purpose) of the VNEs in order to satisfy privacy and regulator requirements.

One embodiment of the invention is a system for virtualized network entities based on network operations support systems, the system comprising;
a virtualized layer-3 network entity (VNE) that provides computing, storage, and networking features or functions for applications or services, wherein the VNE is attached by an open and interoperable interface;
a network operations support system (NOSS), wherein the NOSS offers VNE-based applications or services support configuration based on dynamic demands; and
wherein the applications or services provide initial, normal or nominal, and overload scenarios based on a VNE configuration request sent to the NOSS.

The system embodiment as above, wherein the VNE includes a router, routing/topology database, DNS, DHCP, firewall, or load balancer.

The system embodiment as above, wherein the VNE includes a compute, storage, link/channel, routing and forwarding table/engine, firewall, policy/service-quality manager, or loan balancer/distributor.

The system embodiment as above, wherein the NOSS is a software-defined multi-protocol network compiler (MPNC).

The system embodiment as above, wherein the NOSS is fully decoupled from an underlying network and is configured to interwork with a NOSS-visor.

The system embodiment as above, wherein the NOSS has full visibility and controllability of the VNE wherein the VNE is attached.

The system embodiment as above, further comprising an auto-commissioning/-decommissioning function.

The system embodiment as above, wherein the system operates over a geographic area wider than a layer-2 and local area network domain.

The system embodiment as above, wherein the NOSS is configured to receive inputs via RESTful APIs in the form of feature requests for initial, nominal, and overload conditions of the applications or services.

The system embodiment as above, wherein the NOSS is configured to generate configuration and interconnection of the VNE.

The system embodiment as in [0036] above, wherein the NOSS is configured to generate configuration and interconnection of the VNE in XML format for initial, nominal, and overload scenarios.

Another embodiment of the invention is a method for virtualized network entities based on network operations support systems, the method comprising:
providing, by a virtualized layer-3 network entity (VNE), computing, storage, and networking features or functions for applications or services, wherein the VNE is attached by an open and interoperable interface;
offering, by a network operations support system (NOSS), VNE-based applications or services support configuration based on dynamic demands; and
wherein the applications or services provide initial, normal or nominal, and overload scenarios based on a VNE configuration request sent to the NOSS.

The method embodiment as above, wherein the VNE includes a router, routing/topology database, DNS, DHCP, firewall, or load balancer.

The method embodiment as above, wherein the VNE includes a compute, storage, link/channel, routing and forwarding table/engine, firewall, policy/service-quality manager, or loan balancer/distributor.

The method embodiment as above, wherein the NOSS is a software-defined multi-protocol network compiler (MPNC).

The method embodiment as above, wherein the NOSS is fully decoupled from an underlying network and is configured to interwork with a NOSS-visor.

The method embodiment as above, wherein the NOSS has full visibility and controllability of the VNE, wherein the VNE is attached.

The method embodiment as above, further comprising auto-commissioning or auto-decommissioning the VNE.

The method embodiment as above, wherein the system operates over a geographic area wider than a layer-2 and local area network domain.

The method embodiment as above, further comprising receiving inputs to the NOSS via RESTful APIs in the form of feature requests for initial, nominal, and overload conditions of the applications or services.

The method embodiment as above, further comprising generating, by the NOSS, configuration and interconnection of the VNE.

The method embodiment as in [0047] above, further comprising generating, by the NOSS, configuration and interconnection of the VNE in XML format for initial, nominal, and overload scenarios.

The method embodiment as above, further comprising management by a VNE-visor.

The method embodiment as in [0049] above, wherein the VNE-visor allocates and de-allocates the VNE and tracks the VNE according to privacy and regulator requirements.

Many modifications and alterations of the new methods and systems described herein may be employed by those skilled in the art without departing from the spirit and scope of the invention which is limited only by the claims. Although the invention has been described and illustrated in exemplary forms with a certain degree of particularity, it is noted that the description and illustrations have been made by way of example only. Specific terms are used in this application in a generic and descriptive sense only and not for purposes of limitation. Numerous changes in the details of construction and combination and arrangement of parts and steps may be made. Accordingly, such changes, alterations, and modifications are intended to be included in the invention, the scope of which is defined by the claims.

What is claimed:

1. A system for virtualized network entities based on network operations support systems, the system comprising:
a virtualized layer-3 network entity (VNE) that provides computing, storage, and networking features or functions for applications or services, wherein the VNE is attached by an open and interoperable interface;
a network operations support system (NOSS), wherein the NOSS offers VNE-based applications or services support configuration based on dynamic demands; and
wherein the applications or services provide initial, normal or nominal, and overload scenarios based on a VNE configuration request sent to the NOSS.

2. The system of claim 1 wherein the VNE includes a router, routing/topology database, DNS, DHCP, firewall, or load balancer.

3. The system of claim 1, wherein the VNE includes a compute, storage, link/channel, routing and forwarding table/engine, firewall, policy/service-quality manager, or loan balancer/distributor.

4. The system of claim 1, wherein the NOSS is a software-defined multi-protocol network compiler (MPNC).

5. The system of claim 1, wherein the NOSS is fully decoupled from an underlying network and is configured to interwork with a NOSS-visor.

6. The system of claim 1, wherein the NOSS has full visibility and controllability of the VNE wherein the VNE is attached.

7. The system of claim 1, further comprising an auto-commissioning/-decommissioning function.

8. The system of claim 1, wherein the system operates over a geographic area wider than a layer-2 and local area network domain.

9. The system of claim 1, wherein the NOSS is configured to receive inputs via RESTful APIs in the form of feature requests for initial, nominal, and overload conditions of the applications or services.

10. The system of claim 1, wherein the NOSS is configured to generate configuration and interconnection of the VNE.

11. The system of claim 10, wherein the NOSS is configured to generate configuration and interconnection of the VNE in XML format for initial, nominal, and overload scenarios.

12. A method for virtualized network entities based on network operations support systems, the method comprising:
providing, by a virtualized layer-3 network entity (VNE), computing, storage, and networking features or functions for applications or services, wherein the VNE is attached by an open and interoperable interface;
offering, by a network operations support system (NOSS), VNE-based applications or services support configuration based on dynamic demands; and
wherein the applications or services provide initial, normal or nominal, and overload scenarios based on a VNE configuration request sent to the NOSS.

13. The method of claim 12, wherein the VNE includes a router, routing/topology database, DNS, DHCP, firewall, or load balancer.

14. The method of claim 12, wherein the VNE includes a compute, storage, link/channel, routing and forwarding table/engine, firewall, policy/service-quality manager, or loan balancer/distributor.

15. The method of claim 12, wherein the NOSS is a software-defined multi-protocol network compiler (MPNC).

16. The method of claim 12, wherein the NOSS is fully decoupled from an underlying network and is configured to interwork with a NOSS-visor.

17. The method of claim 12, wherein the NOSS has full visibility and controllability of the VNE, wherein the VNE is attached.

18. The method of claim 12, further comprising auto-commissioning or auto-decommissioning the VNE.

19. The method of claim 12, wherein the system operates over a geographic area wider than a layer-2 and local area network domain.

20. The method of claim 12, further comprising receiving inputs to the NOSS via RESTful APIs in the form of feature requests for initial, nominal, and overload conditions of the applications or services.

21. The method of claim 12, further comprising generating, by the NOSS, configuration and interconnection of the VNE.

22. The method of claim 21, further comprising generating, by the NOSS, configuration and interconnection of the VNE in XML format for initial, nominal, and overload scenarios.

23. The method of claim 12, further comprising management by a VNE-visor.

24. The method of claim 23, wherein the VNE-visor allocates and de-allocates the VNE and tracks the VNE according to privacy and regulator requirements.
